(19) United States
(12) Patent Application Publication
(10) Pub. No.: US 2019/0338177 A1
(43) Pub. Date: Nov. 7, 2019

(54) Thermally Stabilized Friction Reduction Compositions and Methods for Use Thereof

(71) Applicant: Integrity Bio-Chemicals, LLC, Cresson, TX (US)

(72) Inventors: Ashoka V.R. MADDURI, Columbus, GA (US); Christopher P. GARDNER, Columbus, GA (US); Sanket GANDHI, Columbus, GA (US)

(73) Assignee: Integrity Bio-Chemicals, LLC, Cresson, TX (US)

(21) Appl. No.: 16/466,733

(22) PCT Filed: Feb. 6, 2018
(86) PCT No.: PCT/US2018/016998

§ 371 Date: Jun. 5, 2019

Related U.S. Application Data
(60) Provisional application No. 62/455,159, filed on Feb. 6, 2017.

(51) Int. Cl. C09K 8/035; C09K 8/68

(52) U.S. Cl. CPC C09K 8/035; C09K 2208/28; C09K 8/68

(57) ABSTRACT

Friction reducing polysaccharide polymers may be stabilized against thermal degradation in performance using a lactate salt. Accordingly, friction reducing compositions may comprise at least one friction reducing polysaccharide polymer that is non-crosslinked, and a lactate salt. A fluid system may comprise the friction reducing compositions. Methods for mitigating friction may comprise introducing a fluid system comprising a lactate salt and at least one friction reducing polysaccharide polymer that is non-crosslinked into a location subject to friction, and exposing the fluid system to a friction-causing event in the location subject to friction.

### CROSS-REFERENCE TO RELATED APPLICATIONS

The present application claims the benefit of priority under 35 U.S.C. § 119 from U.S. Provisional Patent Application 62/455,159, filed on Feb. 6, 2017 and incorporated herein by reference in its entirety.

### STATEMENT REGARDING FEDERALLY SPONSORED RESEARCH OR DEVELOPMENT

Not applicable.

### BACKGROUND

Friction inevitably occurs in a number of applications and processes where fluids are used, particularly during fluid flow or fluid circulation. If friction becomes excessive when using a fluid, increased energy consumption overcome the friction may lead to an undesirable decrease in process efficiency. Frictional heating may also be problematic in some instances. Under certain circumstances, a fluid experiencing excessive friction may no longer perform as intended and/or experience performance degradation during use, which may further exacerbate efficiency decreases.

Hydraulic systems, such as those utilizing fluid systems for debris or particulate conveyance during a drilling or fracturing operation, represent one type of application in which friction can be problematic. Drilling fluids used in the course defining a wellbore during drilling operation or a mining operation, for example, may aid in hydraulically conveying drilling debris, including metal shavings and/or drill cuttings, from the immediate proximity of the drilling region to the earth's surface. Fracturing fluids similarly may aid in transporting proppant particulates to a subterranean fracture during a fracturing operation. To attain sufficient carrying capacity, drilling or fracturing fluids may comprise polymers that promote high viscosity levels. Unfortunately, high viscosity levels lead to friction when flowing or circulating the fluid, along with correspondingly increased energy requirements in order to maintain fluid functionality during flow or circulation. In certain instances, turbulence at high flow or circulation rates may likewise contribute to excessive friction and high energy consumption levels. Other viscosified fluid systems may similarly be subject to excessive friction and undesirable energy consumption requirements.

To overcome friction and maintain fluid functionality, increased pressures may be utilized when flowing or circulating a fluid. Aside from raising safety concerns, increased fluid pressures also may limit injection rates to an extent that a large proportion of the energy available to a process is dedicated to overcoming friction, again impacting process efficiency.

Friction reducers, which are commonly friction reducing polymers, are often incorporated in fluid systems to decrease energy requirements during use. More specifically, friction reducers may allow fluid systems to maintain sufficient hydraulic carrying capacity while reducing the overall viscosity. As such, friction reducers allow a fluid system's functionality to be maintained while providing more efficient operation. Acrylamide polymers, including polyacrylamide and partially hydrolyzed polyacrylamides, represent one class of friction reducers that have been utilized extensively throughout several industries for a number of years. Polysaccharides such as guar and guar derivatives have also been used for this purpose in some instances.

Although friction reducers may decrease the amount of friction a fluid system experiences, some friction inevitably remains present during fluid flow or fluid circulation. In addition to the decrease in efficiency as a result of friction, frictional heating may also require appropriate management to avoid unwanted temperature increases within the fluid system. Further, a number of processes may also occur in high-temperature locales, such as within a subsurface well or subterranean formation, which may require friction reduction to occur at high temperatures. Unfortunately, a number of friction reducers, including polyacrylamide and partially hydrolyzed polyacrylamides, demonstrate performance losses at increased temperatures. As such, excessive temperatures may lessen overall process efficiency to an unacceptable degree in some instances, especially in the drilling and mining industries.

Another deficiency of conventional friction reducers is that many are salt intolerant and decrease in performance in salt-containing fluids. In some instances, the presence of salt within a fluid system can prevent proper polymer hydration from occurring, thereby leading to the decreased performance. Since salt-containing fluids are commonly used in many industries, including the fluids used in the drilling and mining industries, it can be difficult to mitigate friction in these types of fluids.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 shows a plot of friction reduction for a guar-polyacrylamide system without calcium lactate being present.

FIG. 2 shows a plot of friction reduction for a guar-polyacrylamide system with calcium lactate present.

### DETAILED DESCRIPTION

The present disclosure generally relates to friction reduction in fluid systems and, more specifically, to compositions and methods for friction reduction that provide increased thermal stability.

As discussed above, the friction generated when flowing or circulating fluid systems can often be problematic. Although friction reducing polymers, such as polyacrylamides and partially hydrolyzed polyacrylamides, may be used to decrease friction in fluid systems in some instances, there can be issues associated with these and other types of friction reducing polymers. One issue is decreased friction reduction performance as the operating temperature of a fluid system increases. Another issue is the limited salt tolerance of many types of friction reducing polymers. Environmental impacts of synthetic polymers such as polyacrylamides may also be problematic in some instances.

The present disclosure describes various compositions for decreasing friction within fluid systems, in which improved thermal and salt tolerance may be realized. Surprisingly, various salts having readily oxidizable hydroxyl groups may improve the thermal performance of friction reducing polysaccharide polymers, particularly those that are non-crosslinked. It is particularly surprising that salts of these types may promote thermal stability without raising an issue of salt tolerance. Neutral compounds, including the free acid or base forms of the foregoing salts, may similarly promote thermal stabilization of the friction reducing polymer in some instances. As such, the present disclosure may allow environmentally benign polysaccharide friction reducing polymers to be utilized under a considerably broader range of thermal conditions than is presently possible.

More specifically, according to various embodiments of the present disclosure, lactate salts may surprisingly enhance the thermal performance of friction reducing polysaccharide polymers, such as guar and dextran. The lactate salts may contain alkali metal, alkaline earth, or ammonium cations and are not understood to promote crosslinking of the friction reducing polysaccharide polymers. Other salts having readily oxidizable hydroxyl groups, such as glycolate salts, may function in a similar manner for promoting thermal stability of the polysaccharide friction reducing polymers.

Accordingly, the compositions disclosed herein may provide significant advantages when incorporated in fluid systems used in locales and processes where excessive friction commonly occurs, such as in drilling operations, mining operations, and hydraulic systems. As such, the compositions disclosed herein advantageously may allow such processes to be performed with increased efficiency than would otherwise be possible.

A further advantage of the compositions disclosed herein is that the friction reducing polysaccharide polymers do not leave a substantial filter cake when utilized in a subterranean environment. Other polymers typically used for friction reduction, in contrast, may require the use of chemical or enzymatic breakers to remove the filter cake and restore flow within a wellbore. As such, the compositions disclosed herein offer both environmental and cost advantages compared to conventional approaches for friction reduction.

Finally, the compositions of the present disclosure also include components that are generally available, non-toxic, do not require special handling during transportation or use, and are straightforward to use with minimal risk of contamination to a job site or the surrounding environment. Accordingly, special handling and/or training for workers is not necessarily required, which can provide significant cost savings.

According to various embodiments, friction reducing compositions of the present disclosure may comprise a lactate salt and at least one friction reducing polysaccharide polymer that is non-crosslinked. As used herein, the term “non-crosslinked” means that there is no bridging group between a first polysaccharide chain and a second polysaccharide chain. The term “non-crosslinked” does not preclude branching from either polymer chain. More specifically, according to various embodiments of the present disclosure, neither the cation nor the anion portion of the lactate salt promotes crosslinking of the at least one friction reducing polysaccharide polymer.

Friction reducing polysaccharide polymers convey reduced friction and drag reducing characteristics to a fluid system. The friction reducing polysaccharide polymers may be viscoelastic polymers, according to various embodiments of the present disclosure. The property of viscoelasticity exhibited by certain fluid systems is well known, such as described in further detail in U.S. Pat. No. 3,472,769, which is incorporated by reference herein. As the term implies, viscoelastic polymers possess both elastic and viscous properties. These polymers exhibit a characteristic viscosity function, which may or may not be dependent on the rate of shear or stress within a fluid system. Such polymers also may exhibit elasticity of shape and a retarded elastic recovery following deformation.

Friction reduction characteristics of the compositions disclosed herein may be easily determined by one having ordinary skill in the art. For example, a standard apparatus for assaying friction reduction may involve pumping the composition from a stainless steel tank through a hard brass tube having a fixed internal diameter. The brass tube may be equipped with a magnetic flow recorder and a set of laboratory test gauges together with a water-to-air-to-mercury monometer for determining pressures. A variable speed Moyno pump can be employed having a defined maximum displacement and a defined maximum output pressure. The composition may be pumped through the brass tube at velocities typically ranging from about 5 to 55 feet per second.

According to various embodiments of the present disclosure, suitable lactate salts may comprise alkali metal, alkaline earth metal, or ammonium salts of lactic acid or any derivative thereof. In more specific embodiments of the present disclosure, suitable lactate salts may include, for example, ammonium lactate, sodium lactate, potassium lactate, calcium lactate, or any combination thereof.

Suitable friction reducing polysaccharide polymers may include polysaccharides among at least one of dextran, guar, any derivative thereof, or any combination thereof. Derivative forms of dextran and guar may include those that maintain friction reduction capabilities, for example. Other suitable friction reducing polysaccharide polymers may include derivatives of cellulose, xanthan, levan, or the like, for example.

In more specific embodiments, the at least one friction reducing polysaccharide polymer may comprise guar, any derivative thereof, or any combination thereof. Guar derivatives suitable for use in the various embodiments of the present disclosure may include carboxyalkyl or hydroxyalkyl derivatives of guar, such as, for example, carboxymethyl guar, carboxymethylhydroxyethyl guar, hydroxyethyl guar, carboxymethylhydroxypropyl guar, ethyl carboxymethyl guar, and hydroxypropylmethyl guar. Similarly, suitable dextran derivatives may include carboxyalkyl or hydroxyalkyl derivatives of dextran, such as, for example, carboxymethyl dextran, carboxymethylhydroxyethyl dextran, hydroxyethyl dextran, carboxymethylhydroxypropyl dextran, ethyl carboxymethyl dextran, and hydroxypropylmethyl dextran.

Dextran polysaccharides are commercially available or may be prepared by fermentation of glucose or other carbohydrates. According to various embodiments, dextran and/or guar may have molecular weights between about 20-25 MDa.

Other friction reducing polymers and/or other components used in conjunction with friction reduction may also be used in combination with the non-crosslinked friction reducing polysaccharide polymer(s) in the compositions disclosed herein. According to some embodiments, the compositions of the present disclosure may further comprise at least one component such as, for example, a polyacrylamide, a partially hydrolyzed polyacrylamide, an oxidized polyacrylamide, methyl cellulose, a copolymer of methyl vinyl ether and maleic anhydride, and a copolymer prepared from substantially equal molecular amounts of vinyl acetate and maleic anhydride, any derivative thereof, or any combination thereof.

Suitable polyacrylamides and related polymers for friction reduction are described further in U.S. Pat. No. 3,472,769, which is incorporated herein by reference in its entirety. Partially hydrolyzed polyacrylamides and derivatives thereof may also be suitable for use in the compositions disclosed herein. As used herein, the term “partially hydrolyzed polyacrylamide” refers to an acrylamide polymer in which a portion of the amide side chains are hydrolyzed to a carboxylic acid. Suitable polyacrylamide derivatives include, for example, hydrolyzed and/or oxidized forms of polyacrylamides and forms of polyacrylamides chemically coupled with other chemical moieties such as, for example, acids, alcohols, hydrazides, alkyl groups and combinations thereof. Certain partially hydrolyzed polyacrylamides may function either as a thickener or as a friction reducer depending on their relaxation time. Relaxation time represents a measure of the relative amounts of viscous and elastic response, and determination of a relaxation time will be familiar to one having ordinary skill in the art. Moreover, one having ordinary skill in the art will understand how to determine whether a partially hydrolyzed polyacrylamide or similar polymer is functioning in a thickening or friction reducing role, given the benefit of the present disclosure.

Methyl cellulose or similar cellulose derivatives may function as a thickening agent in the compositions disclosed herein. The copolymer of vinyl acetate and maleic anhydride may similarly provide thickening effects in the compositions disclosed herein. Such copolymers may include tin-neutralized forms or salts thereof, such as the calcium salt, as described in U.S. Pat. No. 2,476,474 and incorporated herein by reference, and/or the un-neutralized copolymer.

Compositions of the present disclosure can be prepared directly on a job site or be transported thereto in a pre-mixed state, optionally in a suitable carrier fluid. In some embodiments, the compositions may be provided in a concentrated form or pre-mixed as solids or liquids to be added to a particular fluid system. The compositions may be in a variety of forms including, for example, mixed or individual dry powders, semi-solids, liquids, gels or slurries that can be added to a fluid system as desired.

According to some embodiments, compositions of the present disclosure may further comprise a carrier fluid. Suitable carrier fluids may include, for example, water, alcohol, salt water, organic liquids, glycols and/or a hydraulic fluid. Carrier fluids may be from any suitable source, provided that the carrier fluid does not impact the desired function of a fluid system and/or the friction reduction function of the friction reducing polysaccharide polymers.

Fluid systems that are presently used in drilling and mining operations, for example, are often used in pressurized systems in which friction can be problematic during fluid flow or fluid circulation. Fluid systems used in such industries may include, for example, water, salt water, organic liquids, alcohols, glycols, or miscible mixtures of water and organic liquids (e.g., alcohols or glycols).

Various additives may be further included in the compositions of the present disclosure, including those used in drilling and mining operations and in other applications where friction may be problematic during fluid flow or fluid circulation. The additives may aid in further reducing friction or provide an unrelated functionality to the fluid system. Such additives will be familiar to one having ordinary skill in the art and may be chosen for a particular application by one having the benefit of the present disclosure and the knowledge of one having ordinary skill in the art. Suitable additives that may be included in the compositions disclosed herein include, for example, one or more of rust prevention or reduction agents, microbial growth inhibitors or microbiocidal agents, chelating agents, acids, bases, buffers, reducing agents, oxidizing agents, salts, agents that increase the useful life of the fluid system or equipment in which the fluid system is operating, dyes, tracers, corrosion inhibitors, solid particulates, carbon-based materials including graphite, graphene or carbon black, identification tags, and any combination thereof.

According to various embodiments, compositions of the present disclosure may exhibit thermal stability at a temperature of about 60° C. or more, or at a temperature of about 80° C. or more, or at a temperature of about 100° C. or more, or at a temperature of about 120° C. or more, or at temperature of about 150° C. or more. As used herein, a composition is considered to maintain thermal stability at a given temperature if the friction reduction in a given fluid system decreases by less than a set threshold (e.g., less than about 10% from a base value) over a given observation period.

Compositions of the present disclosure may contain a wide range of amounts of the friction reducing polysaccharide polymer, the lactate salt, and a carrier fluid, when present.

In some embodiments, compositions of the present disclosure may contain about 1% to about 80% of the friction reducing polysaccharide polymer by weight, or about 20% to about 80% of the friction reducing polysaccharide polymer by weight. In more specific embodiments, the friction reducing polysaccharide polymer may be present in an amount ranging between about 20% to about 30% by weight, or between about 30% to about 40% by weight, or between about 40% to about 50% by weight, or between about 50% to about 60% by weight, or between about 60% to about 70% by weight, or between about 70% to about 80% by weight.

In some embodiments, compositions of the present disclosure may contain about 0.5% to about 50% of the lactate salt by weight or about 1% to about 25% of the lactate salt by weight. In more specific embodiments, the lactate salt may be present in an amount ranging between about 1% to about 40% by weight, or between about 1% to about 5% by weight, or between about 5% to about 10% by weight, or between about 15% to about 20% by weight, or between about 20% to about 25% by weight, or between about 25% to about 30% by weight, or between about 30% to about 35% by weight, or between about 35% to about 40% by weight.

In compositions including a carrier fluid, the carrier fluid may be present in an amount of about 60% by weight of the composition of greater, according to various embodiments. In more specific embodiments, the compositions may contain about 60% to about 70% carrier fluid by weight, or between about 70% to about 80% carrier fluid by weight.

In still more specific embodiments, compositions of the present disclosure may contain at least 60% of the carrier fluid by weight, at least 20% of the friction reducing polysaccharide polymer by weight, and at least 1% of the lactate salt by weight. In some or other embodiments, the compositions may comprise about 1% to about 50% by weight friction reducing polysaccharide polymer and about 0.1% to about 25% by weight of the lactate salt. In still more specific embodiments, the compositions may comprise about 15% to about 40% by weight of the friction reducing polysaccharide polymer and about 5% to about 15% by weight of the lactate salt.

Accordingly, the present disclosure also provides methods for mitigating friction and frictional inefficiencies in locales wherein a flowing or circulating fluid system is subject to a friction-causing event. In illustrative embodiments, the location subject to friction may comprise at least a portion of a drilling operation, a fracturing operation, a mining operation, or a hydraulic system. More specifically, the compositions disclosed herein may be used in conjunction with various applications in which a fluid system is flowed or circulated, possibly under turbulent flow conditions. Any of the compositions disclosed above may be utilized in the methods discussed further herein.

According to various embodiments, methods of the present disclosure may comprise introducing a fluid system comprising at least one friction reducing polysaccharide polymer and a lactate salt into a location subject to friction, and exposing the fluid system to a friction-causing event in the location subject to friction. The at least one friction reducing polysaccharide polymer is non-crosslinked, according to various embodiments. In various embodiments, the friction-causing event may comprise flowing and/or circulating the fluid system within or to/from the location subject to friction. The location subject to friction may encompass any of pipes, valves, tubulars, wellbores, and the like.

According to more specific embodiments, the location subject to friction may comprise at least a portion of a drilling operation, a fracturing operation, a mining operation, or a hydraulic system. Such locations may include pumping operations used in drilling, fracturing and mining systems that require a high fluid carrying capacity. Hydraulic systems such as vehicle braking systems, aircraft control systems, and the like may benefit from the present disclosure. Such systems often operate at pressures or fluid velocities that may generate frictional heat and may overheat. The compositions of the present disclosure provide heat stability to the fluid systems, which may provide for a longer useful life and a wider and broader range of utility.

In some embodiments, methods of the present disclosure may further comprise combining the at least one friction reducing polysaccharide polymer and the lactate salt with a carrier fluid to form the fluid system. In some embodiments, combining the at least one friction reducing polysaccharide polymer and the lactate salt with the carrier fluid may take place at a job site. In other embodiments, the fluid systems may be pre-formulated with a carrier fluid and are transported to a job site for use.

Embodiments disclosed herein include:

A. Compositions for reducing friction. The compositions comprise: at least one friction reducing polysaccharide polymer that is non-crosslinked; and a lactate salt.

B. Methods for reducing friction. The methods comprise: introducing a fluid system comprising at least one friction reducing polysaccharide polymer and a lactate salt into a location subject to friction; wherein the at least one friction reducing polysaccharide polymer is non-crosslinked; and exposing the fluid system to a friction-causing event in the location subject to friction.

Embodiments A and B may have one or more of the following additional elements in any combination.

Element 1: wherein the at least one friction reducing polysaccharide polymer comprises guar, any derivative thereof, or any combination thereof.

Element 2: wherein the composition further comprises: at least one component selected from the group consisting of a polyacrylamide, an oxidized polyacrylamide, a partially hydrolyzed polyacrylamide, any derivative thereof, and any combination thereof.

Element 3: wherein the composition further comprises: at least one component selected from the group consisting of a polyacrylamide, an oxidized polyacrylamide, a partially hydrolyzed polyacrylamide, methyl cellulose, a copolymer of methyl vinyl ether and maleic anhydride, a copolymer prepared from substantially equimolar amounts of vinyl acetate and maleic anhydride, any derivative thereof, and any combination thereof.

Element 4: wherein the at least one friction reducing polysaccharide polymer comprises one or more of dextran, guar, any derivative thereof, or any combination thereof.

Element 5: wherein the lactate salt is selected from the group consisting of sodium lactate, potassium lactate, ammonium lactate, calcium lactate, any derivative thereof, and any combination thereof.

Element 6: wherein the composition further comprises a carrier fluid.

Element 7: wherein the composition comprises about 1% to about 50% by weight of the at least one friction reducing polysaccharide polymer and about 0.1% to about 25% by weight of the lactate salt.

Element 8: wherein the composition comprises about 15% to about 40% by weight of the at least one friction reducing polysaccharide polymer and about 5% to about 15% by weight of the lactate salt.

Element 9: wherein the location subject to friction comprises at least a portion of a drilling operation, a fracturing operation, a mining operation, or a hydraulic system.

Element 10: wherein the fluid system further comprises at least one component selected from the group consisting of a polyacrylamide, an oxidized polyacrylamide, a partially hydrolyzed polyacrylamide, any derivative thereof, and any combination thereof.

Element 11: wherein the fluid system further comprises at least one component selected from the group consisting of a polyacrylamide, an oxidized polyacrylamide, a partially hydrolyzed polyacrylamide, methyl cellulose, a copolymer of methyl vinyl ether and maleic anhydride, a copolymer prepared from substantially equimolar amounts of vinyl acetate and maleic anhydride, any derivative thereof, and any combination thereof.

Element 12: wherein the fluid system is at a temperature of about 60° C. or above when present in the location subject to friction.

Element 13: wherein the method further comprises: combining the at least one friction reducing polysaccharide polymer and the lactate salt with a carrier fluid to form the fluid system.

By way of non-limiting example, exemplary combinations applicable to A include: 1 and 2; 1 and 3; 2 and 4; 3 and 4; 1 and 5; 2 and 5; 3 and 5; 4 and 5; 1 and 6; 2 and 6; 3 and 6; 4 and 6; 5 and 6; 1 and 7; 2 and 7; 3 and 7; 4 and 7; 5 and 7; 6 and 7; 1 and 8; 2 and 8; 3 and 8; 4 and 8; 5 and 8; 6 and 8; and 7 and 8. By way of non-limiting example, exemplary combinations applicable to B include: 1 and 9; 1 and 10; 1 and 11; 1 and 12; 1 and 13; 4 and 9; 4 and 10; 4 and 11; 4 and 12; 4 and 13; 1 and 5; 4 and 5; 5 and 9; 5 and 10; 5 and 11; 5 and 12; 5 and 13; 9 and 10; 9 and 11; 9 and 12; 9 and 13; 10 and 12; 10 and 13; 12 and 13; 11 and 12; and 11 and 13.

To facilitate a better understanding of the embodiments described herein, the following examples of various representative embodiments are given. In no way should the following examples be read to limit, or to define, the scope of the invention.

### EXAMPLES

### Example 1: Friction Loop Procedure

Dry samples of guar, polyacrylamide, and a 1:3 combination of guar and polyacrylamide (HP 2704, available from HPPE, Columbus, Ga.) were weighed out using a digital balance. An amount of tap water sufficient to prepare a 0.5 gpt (gallons per 1000 gallons) solution for each substance was poured into a flow loop hopper paired with a mechanical stirrer. With the mechanical stirrer operating at a constant rate, the dry samples were added and hydrated for three minutes. Immediately after three minutes of mixing, the hydrated fluid samples were pumped into the flow loop at a constant flow rate. The percent friction reduction was calculated based on differential pressure drop observed compared to the same sample without the friction reducer being present. Comparison experiments with a 3% aqueous KCl carrier fluid were also performed. Calcium lactate was not utilized in this example.

Table 1 below summarizes the friction reduction performance of each fluid system.

TABLE 1

| Fluid System | Friction reduction (%) |
|---|---|
| Polyacrylamide in tap water | 68 |
| Guar in tap water | 64 |
| 1:3 Gaur/Polyacrylamide in tap water | 70 |
| Polyacrylamide in 3% KCl | 60 |
| 1:3 Guar/Polyacrylamide in 3% KCl | 68 |

As shown by the data, the performance in the aqueous salt solution was slightly worse than in comparable fluids formulated with tap water.

### Example 2: Rheology Measurements Using a Grace 5600 Rheometer

Friction reduction performance for 1:3 guar/polyacrylamide with and without added calcium lactate was obtained using a Grace 5600 rheometer. 300 mL of deionized water was poured into blender beaker and combined with 0.3 g of the product to be tested. Blending was conducted for 3 minutes at high shear. After the 3 minute blending time, the mixture was transferred to the sample cup of the Grace 5600 rheometer and tested using a shear-temperature-pressure testing method. Results are shown in Table 2.

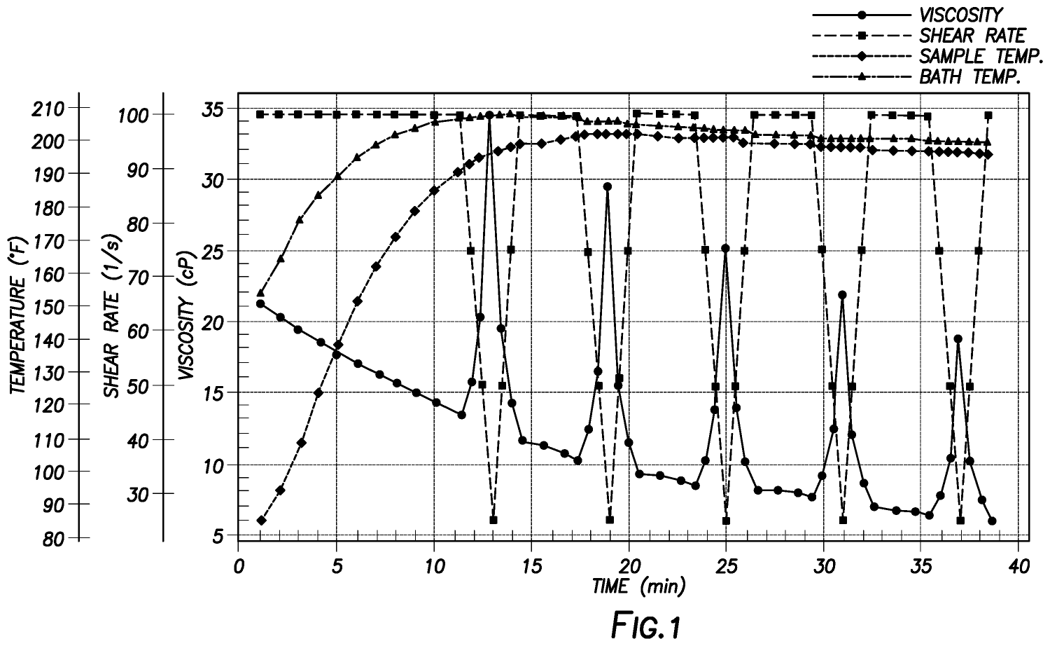

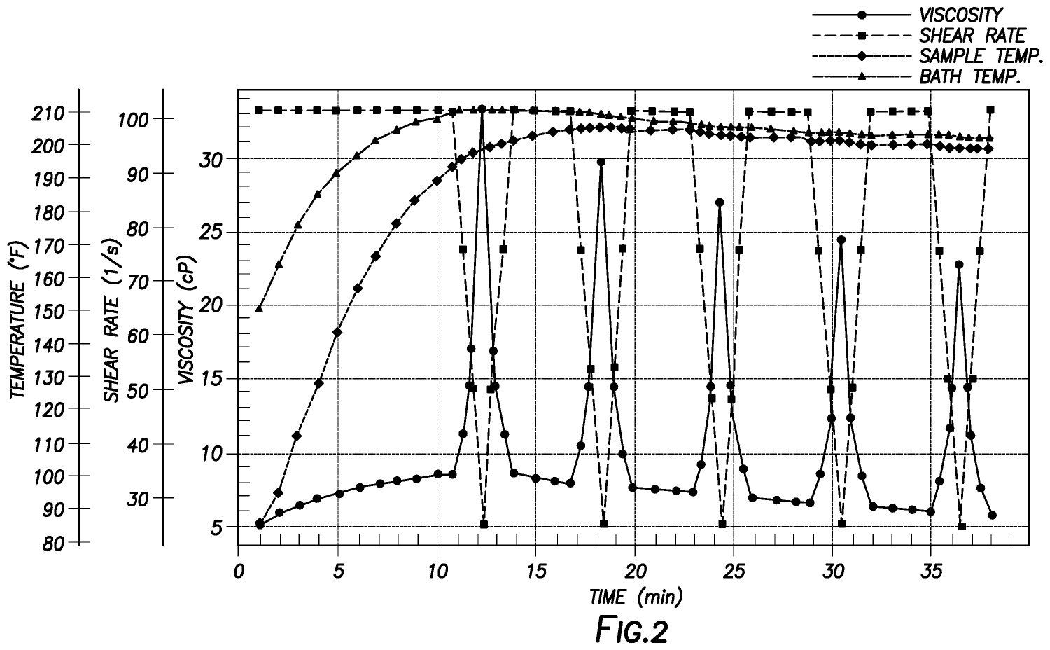

FIGS. 1 and 2 show illustrative plots of the rheology performance for 1:3 guar/polyacrylamide without and with added calcium lactate, respectively. Table 2 below summarizes the friction reduction performance for each fluid system as a function of time.

TABLE 2

| | | 1:3 |
|---|---|---|
| | 1:3 | Guar/Polyacrylamide |
| | Guar/Polyacrylamide | with Ca Lactate |
| Time (min.) @ | Viscosity (cP) | Viscosity (cP) |
| 200° F. (93° C.) | FIG. 1 | FIG. 2 |
| 10-15 | 34 | 34 |
| 15-21 | 30 | 30 |
| 21-27 | 25 | 28 |
| 27-33 | 22 | 25 |
| 33-39 | 17 | 23 |

As shown, the inclusion of calcium lactate maintained viscosity of the fluid system over a longer period of time, which is indicative of improved friction reducing performance at a temperature where both guar and polyacrylamide are otherwise less effective for reducing friction.

Unless otherwise indicated, all numbers expressing quantities and the like in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

One or more illustrative embodiments incorporating various features are presented herein. Not all features of a physical implementation are described or shown in this application for the sake of clarity. It is understood that in the development of a physical embodiment incorporating the embodiments of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While various systems, tools and methods are described herein in terms of “comprising” various components or steps, the systems, tools and methods can also “consist essentially of” or “consist of” the various components and steps.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Therefore, the disclosed systems, tools and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems, tools and methods illustratively disclosed herein may suitably be practiced in the absence of any element that is not specifically disclosed herein and/or any optional element disclosed herein. While systems, tools and methods are described in terms of “comprising,” “containing,” or “including” various components or steps, the systems, tools and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

What is claimed is the following:

1. A composition comprising:
at least one friction reducing polysaccharide polymer that is non-crosslinked; and
a lactate salt.

2. The composition of claim 1, wherein the at least one friction reducing polysaccharide polymer comprises guar, any derivative thereof, or any combination thereof.

3. The composition of claim 2, further comprising:
at least one component selected from the group consisting of a polyacrylamide, an oxidized polyacrylamide, a partially hydrolyzed polyacrylamide, any derivative thereof, and any combination thereof.

4. The composition of claim 2, further comprising:
at least one component selected from the group consisting of a polyacrylamide, an oxidized polyacrylamide, a partially hydrolyzed polyacrylamide, methyl cellulose, a copolymer of methyl vinyl ether and maleic anhydride, a copolymer prepared from substantially equimolar amounts of vinyl acetate and maleic anhydride, any derivative thereof, and any combination thereof.

5. The composition of claim 1, wherein the at least one friction reducing polysaccharide polymer comprises one or more of dextran, guar, any derivative thereof, or any combination thereof.

6. The composition of claim 5, further comprising:
at least one component selected from the group consisting of a polyacrylamide, an oxidized polyacrylamide, a partially hydrolyzed polyacrylamide, methyl cellulose, a copolymer of methyl vinyl ether and maleic anhydride, a copolymer prepared from substantially equimolar amounts of vinyl acetate and maleic anhydride, any derivative thereof, and any combination thereof.

7. The composition of claim 1, wherein the lactate salt is selected from the group consisting of sodium lactate, potassium lactate, ammonium lactate, calcium lactate, any derivative thereof, and any combination thereof.

8. The composition of claim 1, further comprising:
a carrier fluid.

9. The composition of claim 8, wherein the composition comprises about 1% to about 50% by weight of the at least one friction reducing polysaccharide polymer and about 0.1% to about 25% by weight of the lactate salt.

10. The composition of claim 9, wherein the composition comprises about 15% to about 40% by weight of the at least one friction reducing polysaccharide polymer and about 5% to about 15% by weight of the lactate salt.

11. A method comprising:
introducing a fluid system comprising at least one friction reducing polysaccharide polymer and a lactate salt into a location subject to friction;
wherein the at least one friction reducing polysaccharide polymer is non-crosslinked; and
exposing the fluid system to a friction-causing event in the location subject to friction.

12. The method of claim 11, wherein the location subject to friction comprises at least a portion of a drilling operation, a fracturing operation, a mining operation, or a hydraulic system.

13. The method of claim 11, wherein the at least one friction reducing polysaccharide polymer comprises guar, any derivative thereof, or any combination thereof.

14. The method of claim 13, wherein the fluid system further comprises at least one component selected from the group consisting of a polyacrylamide, an oxidized polyacrylamide, a partially hydrolyzed polyacrylamide, any derivative thereof, and any combination thereof.

15. The method of claim 13, wherein the fluid system further comprises at least one component selected from the group consisting of a polyacrylamide, an oxidized polyacrylamide, a partially hydrolyzed polyacrylamide, methyl cellulose, a copolymer of methyl vinyl ether and maleic anhydride, a copolymer prepared from substantially equimolar amounts of vinyl acetate and maleic anhydride, any derivative thereof, and any combination thereof.

16. The method of claim 11, wherein the at least one friction reducing polysaccharide polymer comprises one or more of dextran, guar, any derivative thereof, or any combination thereof.

17. The method of claim 16, wherein the fluid system further comprises at least one component selected from the group consisting of a polyacrylamide, an oxidized polyacrylamide, a partially hydrolyzed polyacrylamide, methyl cellulose, a copolymer of methyl vinyl ether and maleic anhydride, a copolymer prepared from substantially equimolar amounts of vinyl acetate and maleic anhydride, any derivative thereof, and any combination thereof.

18. The method of claim 11, wherein the lactate salt is selected from the group consisting of sodium lactate, potassium lactate, ammonium lactate, calcium lactate, any derivative thereof, and any combination thereof.

19. The method of claim 11, wherein the fluid system is at a temperature of about 60° C. or above when present in the location subject to friction.

20. The method of claim 11, further comprising:
combining the at least one friction reducing polysaccharide polymer and the lactate salt with a carrier fluid to form the fluid system.
